(19) United States
(12) Patent Application Publication
(10) Pub. No.: US 2011/0102523 A1
(43) Pub. Date: May 5, 2011

(54) COMPATIBLE INK CARTRIDGE FOR LARGE FORMAT INK JET PRINTERS

(76) Inventor: Jack CHEN, Taichung City (TW)

(21) Appl. No.: 12/868,180

(22) Filed: Aug. 25, 2010

(30) Foreign Application Priority Data
Oct. 29, 2009 (TW) 98136770

(51) Int. Cl. B41J 2/175

(52) U.S. Cl. 347/87

(57) ABSTRACT

The present invention relates to a compatible ink cartridge for large format ink jet printers, consisting of an insertable cartridge and an ink container that can be integrated with said cartridge. The front end of said cartridge has a nozzle through which the large format ink jet printer's ink supply needle is inserted. Said ink container has a front end facing said nozzle of said cartridge, said front end having a soft plug through which the large format ink jet printer's ink supply needle can be inserted to access ink from said ink container.

### BACKGROUND OF THE INVENTION

1. Field of the Invention

The present invention relates generally to ink supply installations of large format ink jet printers and particularly to a compatible ink cartridge for large format ink jet printers.

2. Description of the Related Art

Traditionally, advertising posters and billboards are printed with large format color ink jet printers using long ink cartridges with ink capacities of between 300 and 1,000 milliliters. OEM ink cartridges seal the ink in a long aluminum foil bag, which is then placed in a long hard-bodied cartridge. The front of the cartridge has a hole that is aligned directly with the top of the aluminum foil bag, which is sealed by a soft plug. The large format ink jet printer's ink supply needle penetrates through the plug to access the contents of the aluminum foil bag. This type of ink cartridge utilizes atmospheric pressure to force ink from the aluminum foil bag to the large format ink jet printer's print head by way of the ink supply needle. In order to detect the ink level, microchips are usually embedded on the exterior of the cartridge. When the ink cartridge is installed in the large format ink jet printer, the printer will automatically record ink usage and indicate the remaining ink level. The ink inside OEM ink cartridges is not exposed to air or light and is of the best quality. However, when the ink is depleted, the cartridge and the microchips must be discarded. This is a waste of resources and is one of the main reasons why OEM ink cartridges are so costly to make. OEM ink cartridges are expensive to buy and are a burden to businesses that use them.

The expensiveness of OEM ink cartridges begot compatible ink cartridges. The most common compatible ink cartridges are made of hard semi-transparent plastic, and the ink is stored inside the cartridge itself. A soft plug is embedded in the front end of the cartridge for penetration by the large format ink jet printer's ink supply needle. The back end of the cartridge has an opening through which the cartridge can be refilled with ink that the user purchases separately. When the ink level in the ink cartridge becomes insufficient, the user can place a funnel in the cartridge opening and slowly pour in the refill ink until the cartridge is full. This refill method often results in spills caused by pouring the refill ink too quickly, thereby staining the printer and adding to the task of cleaning up. Users may not clean the funnel after each use due to the frequency of refills, which will cause ink residue to build up on the funnel. Exposure of the residue to air will cause it to dry up and form particles that will fall into the cartridge during the next refill, thereby reducing the quality of the ink. Other than being used for refills, the said cartridge opening also serves as a vent, increasing the atmospheric pressure on the surface of the ink inside the cartridge and facilitating the suction of ink by the ink supply needle of the large format ink jet printer. However, the ink inside the cartridge, especially the surface layer of the ink, is thereby constantly exposed to air, increasing the likelihood of the deterioration of the ink. Even though the ink is constantly replenished, the surface layer of the ink that is exposed to air probably never gets used, becoming viscous over time and sticking to the inside walls of the cartridge. The residue on the inside walls of the cartridge will dry up to form particles that will fall into the ink with the rise and fall of the ink level, affecting not only the quality of the ink but possibly clogging up the ink supply needle, ink supply tubing, print head, or nozzles. Some large format ink jet printers are equipped with microchips that detect ink level. On these models, in order to replace the microchips, compatible ink cartridges have to be taken out from time to time and then reinstalled. The frequent removal and insertion of the ink cartridge will cause the soft plug on the front end of the cartridge to become loose and result in ink leakage. This is a disadvantage of compatible ink cartridges.

### SUMMARY OF THE INVENTION

The main objective of the present invention is to provide a compatible ink cartridge for large format ink jet printers that is more affordable than OEM ink cartridges.

Another objective of the present invention is to provide a compatible ink cartridge for large format ink jet printers that is easy to use and superior in quality.

To achieve the above objectives, a compatible ink cartridge for large format ink jet printers according to the present invention consists of a hard-bodied cartridge and an ink container that can be integrated with said cartridge to form an ink cartridge. Said hard-bodied cartridge will have connecting parts that have matching shapes with the large format ink jet printer's OEM ink cartridge so that said connecting parts will fit onto said printer when installed. Ink will be stored in said ink container. The front end of said cartridge has a nozzle through which the large format ink jet printer's ink supply needle is inserted. Said ink container has a front end facing said nozzle of said cartridge, said front end having a soft plug through which said ink supply needle can be inserted to access ink from said ink container. If the large format ink jet printer requires microchips that detect ink level (some models have no such requirement), said microchips will be located on the exterior of the cartridge. This way, when ink is depleted, only the ink container needs to be replaced. There will be no need for funnels, and ink replenishment will be quick and convenient. Ink needs a container anyway. Traditionally, ink containers for compatible products serve only as containers. Ink needs to be carefully poured into the compatible cartridge by the user. The ink container of the present invention has a front end with a soft plug. Said ink container can quickly and conveniently supply ink directly to the cartridge. The cartridge of the present invention becomes the interface between the large format ink jet printer and the ink container. Said cartridge will be a fixed component that will not need to be discarded, greatly reducing maintenance costs. As for printer models that require microchips, microchips will only need to be replaced when the ink container is replaced.

### BRIEF DESCRIPTION OF THE DRAWINGS

FIG. 1 is a three-dimensional exterior view of a first embodiment of the present invention.

FIG. 2 is a structural diagram of a first embodiment of the present invention.

FIG. 3 is a structural diagram of the shell of a first embodiment of the present invention.

FIG. 4 is a frontal view of the ink container of a first embodiment of the present invention.

FIG. 4A is a cross-sectional view taken along line A-A of FIG. 4.

FIG. 5 is a frontal view of the front end of the ink container of a first embodiment of the present invention.

FIG. 6 is a bottom view of the ink container of a first embodiment of the present invention.

FIG. 7 is an application diagram of a first embodiment of the present invention.

FIG. 8 is a magnified view of the front end of the ink cartridge in FIG. 7.

FIG. 9 is a magnified view of the outlet of the ink container in FIG. 8.

FIG. 10 is a structural diagram of a second embodiment of the present invention.

FIG. 11 is a structural diagram of a third embodiment of the present invention.

### DETAILED DESCRIPTION OF THE INVENTION

Below are three illustrated exemplary embodiments of the present invention.

As illustrated, an ink cartridge (10) of the first embodiment of the present invention consists of:

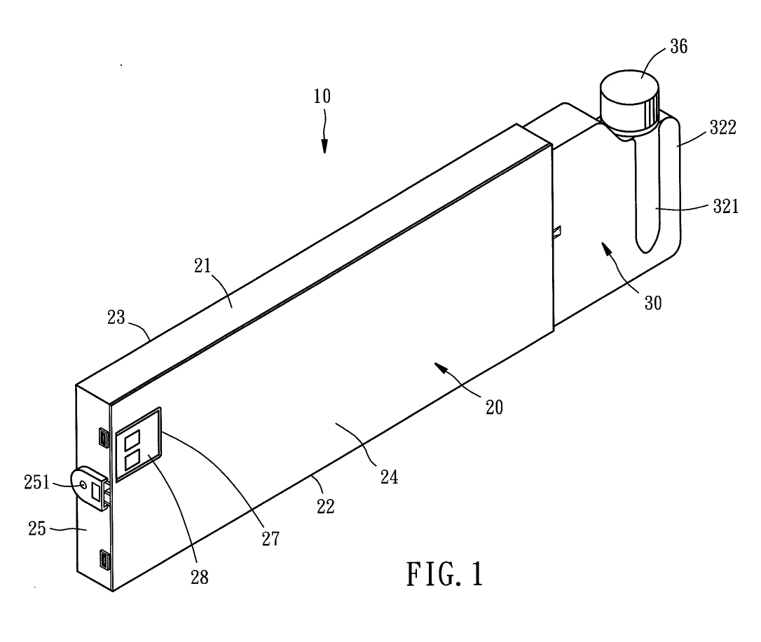

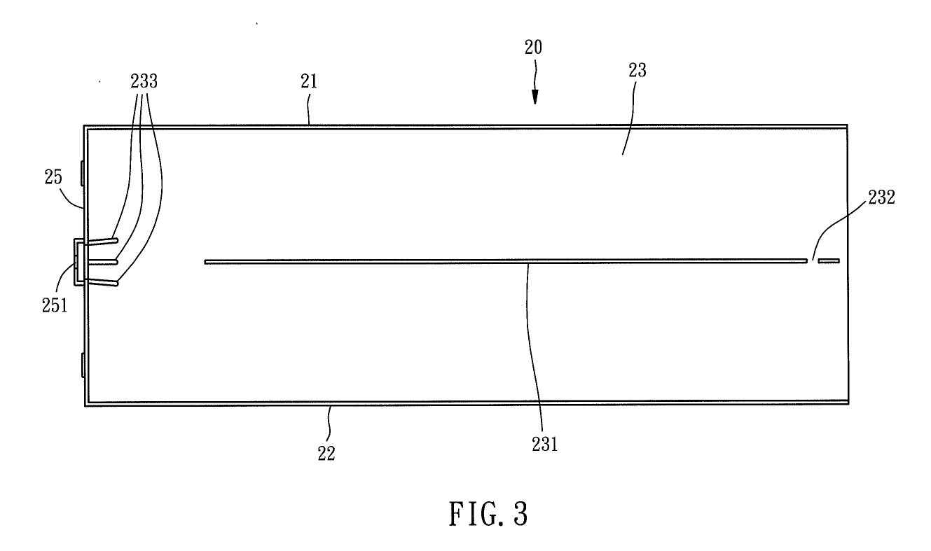

A cartridge (20), as illustrated in FIG. 1 and FIG. 3, is a shell made of hard plastic. The top, bottom, left, right, and front walls of the shell (21) (22)(23)(24) (25) form cavity (26), leaving an opening in the back end. The front wall of the shell has a nozzle (251).

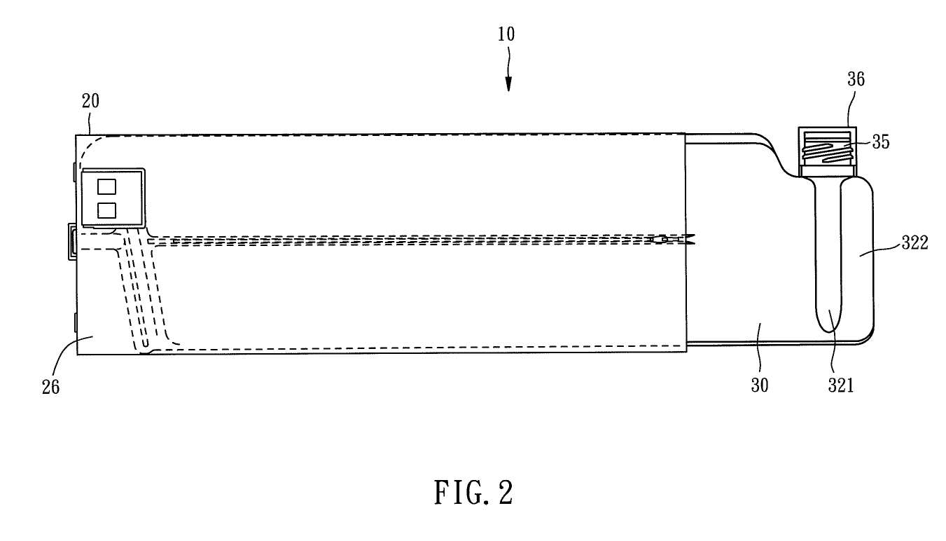

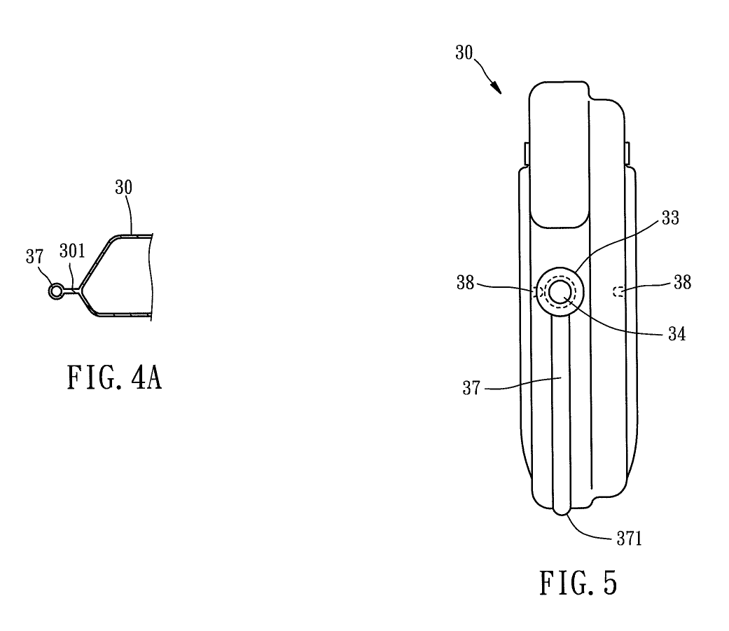

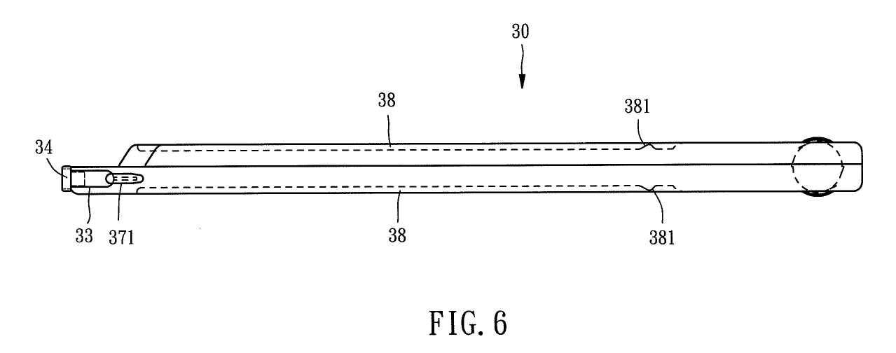

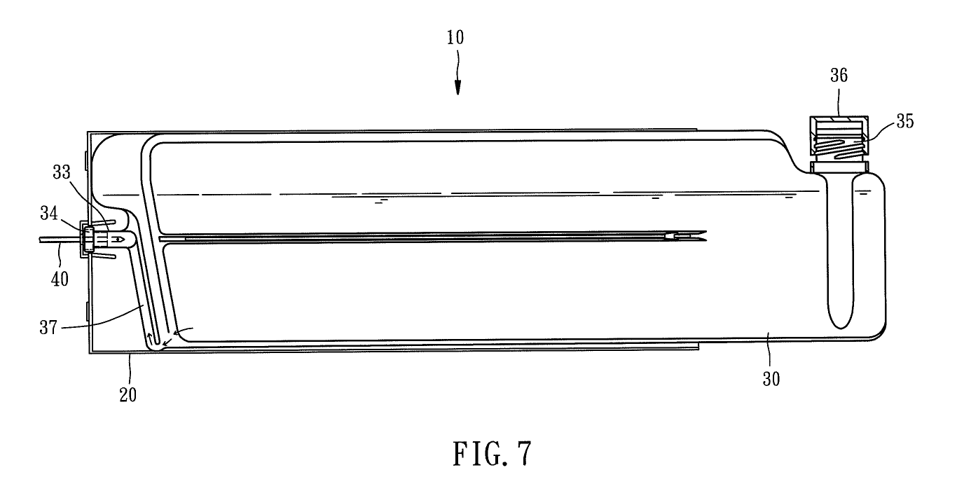

An ink container (30), as illustrated in FIGS. 1, 2, 4, 5, and 6, is a semi-transparent bottle formed by blow molded soft plastic consisting of a front end (31) and a back end (32). Said front end (31) fits inside cavity (26) of cartridge (20). Said back end (32) protrudes out of cartridge (20). Said front end (31) has an outlet (33), which aligns directly with nozzle (251) on the front wall of cartridge (20). Said outlet (33) has a soft plug (34) used to plug up outlet (33). The large format ink jet printer's ink supply needle (40) can be inserted through soft plug (34) as shown in FIG. 7. Said back end (32) has a bottle opening (35) sealed by bottle cap (36). Said bottle opening (35) can be used for ink refills and serve as a vent.

The present invention's ink cartridge (10) is formed by integrating hard-bodied cartridge (20) with ink container (30). The shape of said hard-bodied cartridge (20) is emulated after the OEM ink cartridge for the model of large format ink jet printer for which it is compatible, thereby allowing the present invention's ink cartridge (10) to be compatibly installed on the large format ink jet printer. Ink container (30) is sold with the ink already inside. There is no need for the user to manually perform the refill, making it quick and easy to use.

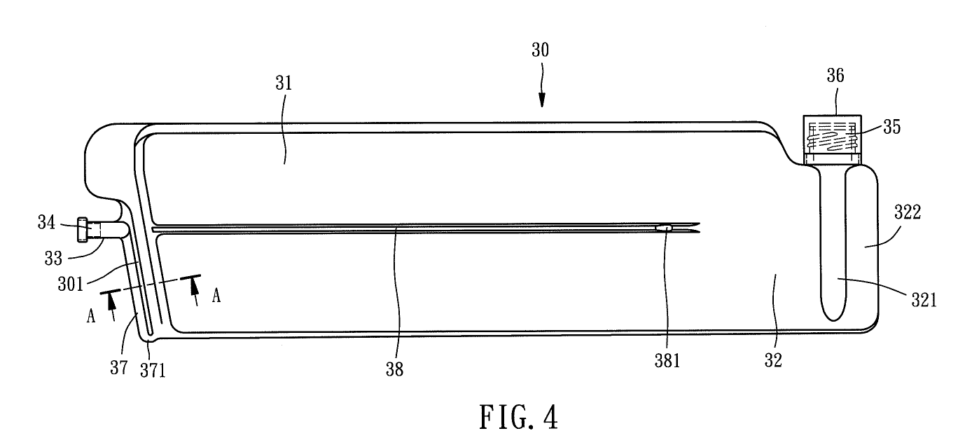

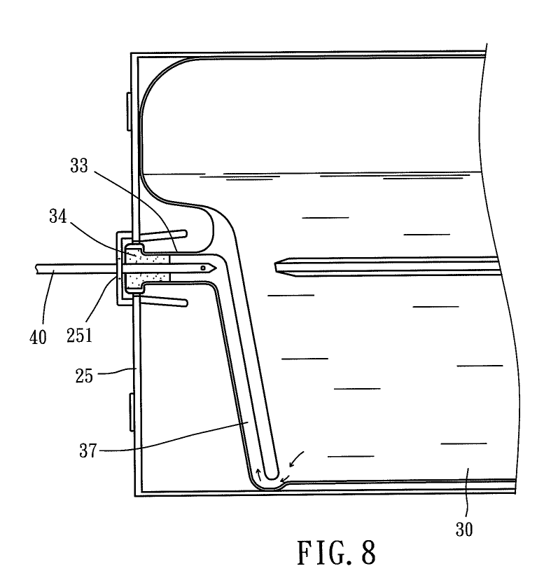

The large format ink jet printer has two types of ink cartridges, vertically inserted and horizontally inserted. The first embodiment is of the horizontal type, as shown in FIG. 4. Because outlet (33) is located about the middle of ink container (30), there is an ink channel (37), one end of which is connected to outlet (33) and the other end of which is connected to the bottom of the ink container. In the first embodiment, the end of ink channel (37) that is connected to the bottom of the ink container forms a curve (371), which is said channel's lowest point, allowing the siphon principle to work by transferring ink from the container to ink supply needle (40), as shown in FIGS. 7 and 8.

In order to stabilize ink container (30) within cartridge (20), in the first embodiment, there are guides on the interiors of the left and right walls (23) (24) of cartridge (20). FIG. 3 shows cartridge (20) without right wall (24), showing guide (231) on left wall (23). Said guide (231) is a long raised track, and at the end of guide (231) near the open end of cartridge (20) is a fixing point (232) (the right wall, being similar, is not shown in the illustration). In the first embodiment, fixing point (232) is a dent in the long raised track. As shown in FIGS. 4, 5, and 6, ink container (30) has a matching guide (38), which in this embodiment is a long groove, to cartridge (20)'s guide (231). Corresponding to fixing point (232) of cartridge (20) is a matching fixing point (381), which in this embodiment is a protrusion. When combined, ink container (30) is inserted into cartridge (20) via cartridge (20)'s open end, and the long grooves (matching guides 38) on the left and right walls of ink container (30) are guided along the long raised tracks (guides 231) on the left and right interior walls of cartridge (20), thereby securing ink container (30) inside cartridge (20). When secured, ink container (30)'s protrusion (matching fixing point 381) is lodged in cartridge (20) dent (fixing point 232). Outlet (33) of ink container (30) is aligned directly with nozzle (251) of cartridge (20). To prevent outlet (33) from shifting, guide (233) as shown in FIG. 3 is located near nozzle (251) of cartridge (20) to guide and secure outlet (33) in place.

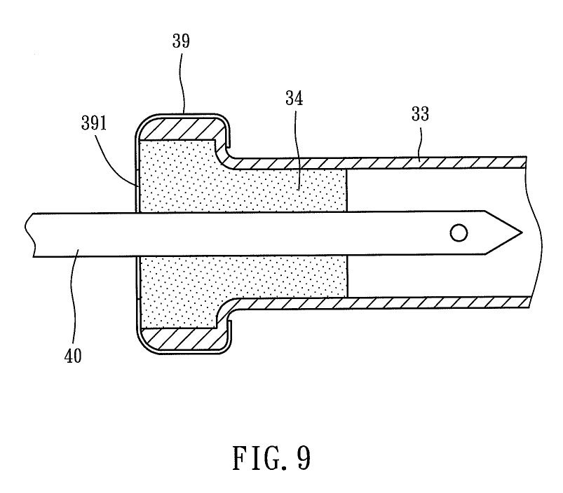

As shown in FIG. 9, soft plug (34) located at the front of outlet (33) of ink container (30) is made of either rubber or plastic. Stabilizer (39) is used to seal soft plug (34) inside outlet (33). In the middle of stabilizer (39) is a hole (391), allowing the large format ink jet printer's ink supply needle (40) to pass through it. In the first embodiment, stabilizer (39) is a thin foil of aluminum metal, similar to the seals on injection drug vials.

As shown in FIG. 4, ink container (30) of this first embodiment is formed by blow molded plastic. Ink channel (37) is formed between the body of the bottle and outlet (33) by connecting wall (301), as shown in FIG. 4A. Also, concavities (321) are located on the left and right walls of back end (32) of ink container (30) to form handle (322) so that ink container (30) may be easily held.

As shown in FIGS. 1 and 3, cartridge (20) of this first embodiment is made of injection blow molded hard plastic. The top, bottom, left and front walls (21)(22) (23) (25) of this first embodiment form the main body, with right wall (24) serving as a lid covering the main body.

As shown in FIG. 1, a side wall of cartridge (20) is equipped with a concavity (27) for the installation of microchip (28). For large format ink jet printers that require microchips, ink container (30) will come with microchip (28). When ink cartridge (10) is removed for the replacement of ink container (30), microchip (28) can be replaced at the same time. Microchip (28) can be secured by a screw, lodged in place, or secured by some other method.

The present invention's ink container (30) has a bottle opening (35) sealed by bottle cap (36). Before use, the user should loosen bottle cap (36), allowing bottle opening (35) to serve as a vent. During periods of non-use such as over the weekend, bottle cap (36) only has to be fastened for ink container (30) to become airtight again. This reduces ink evaporation, prevents thickening of the ink, and ensures ink quality.

If the ink level inside ink container (30) becomes insufficient to sustain printing, the user can first install a new ink container and then pour the remaining ink from the old container into the new container, completely avoiding the waste of ink.

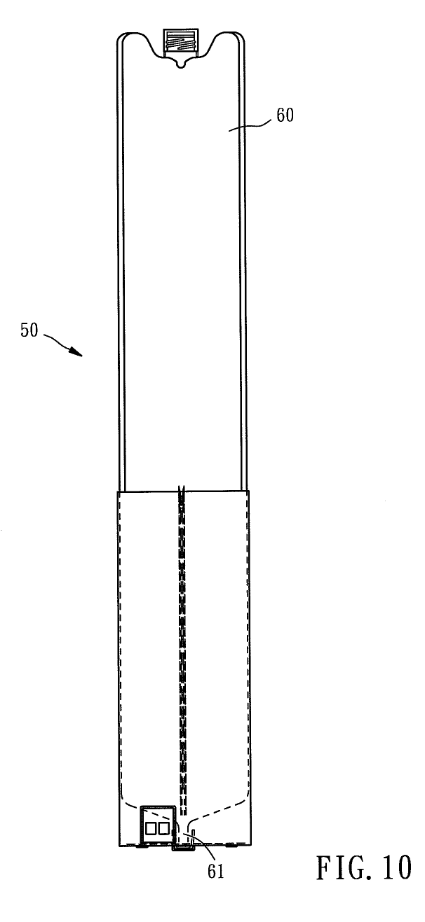

The present invention's second embodiment is shown in FIG. 10. Ink cartridge (50) is a vertical ink cartridge, which eliminates the need for ink container (60) to have an ink channel such as ink channel (37) of the first embodiment. Ink container (60) is like a wine bottle wherein all the ink will naturally flow to outlet (61).

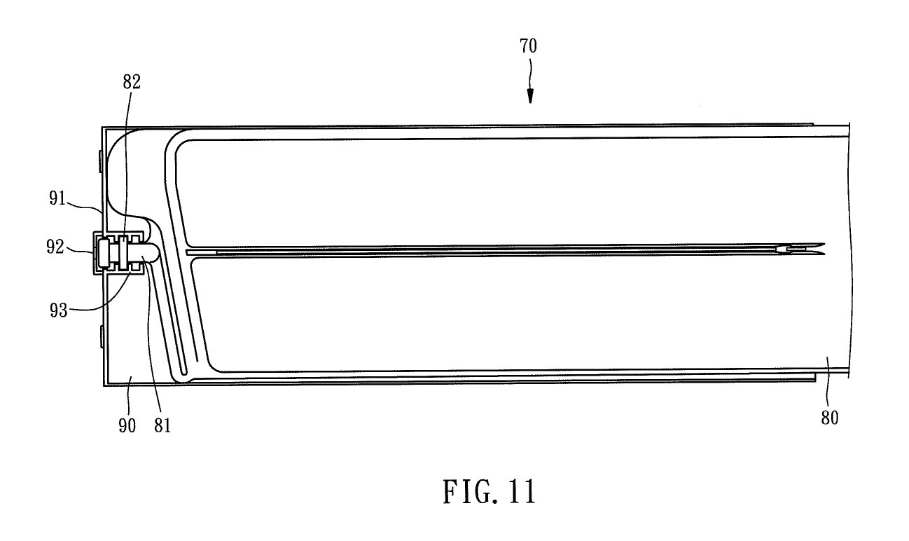

The present invention's third embodiment is shown in FIG. 11. Ink cartridge (70) is different in that ink container (80) is not inserted through the open end of cartridge (90). Cartridge (90) is designed similarly to the main body and lid of the first embodiment. Front wall (91) of the main body near nozzle (92) has a matching locking part (93), and outlet (81) of ink container (80) has a locking part (82) that interlocks with cartridge (90)'s matching locking part (93) to secure outlet (81) in place. The cartridge (90) can be formed by the left and right walls as a body-and-lid combination, the matching locking part (93) is on one of said walls, the lid (not shown in the illustration) covers the main body and can be secured with screws.

The above embodiments are exemplary only and are not limitations on the present invention. For example, the ink containers of the embodiments have a bottle opening and a bottle cap, but they are not required elements. Ink containers are filled with ink and sealed at the factory. The seal can be broken before use to serve as a vent, or a needle can be used to prick a hole and create a vent. A part of the ink container protrudes out from the cartridge to make it easier to detect the ink level. However, if the large format ink jet printer uses microchips to detect ink level, then the ink container protrusion would not be a necessary part of the design. If it were necessary to open the cartridge to replace the ink container, as in the third embodiment, then it would be appropriate to fit the entire ink container inside the protection of the cartridge.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A compatible ink cartridge of a large format ink jet printer, comprising:
a cartridge made of a hard shell with top, bottom, left, right, and front walls to form a cavity with an opening in the back, said front wall having a nozzle;
an ink container formed by blow molded plastic consisting of a front end and a back end, said front end fitting inside said cartridge and said back end protruding out from said cartridge; said front end having an outlet with a soft plug used to plug up said outlet, which aligns directly with said nozzle on said front wall.

2. The compatible ink cartridge of a large format ink jet printer of claim 1, wherein said back end of said ink container has a vent sealed by a cap.

3. The compatible ink cartridge of a large format ink jet printer of claim 2, wherein said back end of said ink container has a bottle opening on the top end, forming said vent and sealed by a screw-on cap.

4. The compatible ink cartridge of a large format ink jet printer of claim 1, wherein there is an ink channel between said front end of said ink container and the body of said container, one end of said ink channel is connected to said outlet and the other end of said ink channel is connected to the bottom of said ink container.

5. The compatible ink cartridge of a large format ink jet printer of claim 1, wherein there are guides on the interiors of the left and right walls of said cartridge, said ink container has matching guides, allowing said cartridge and said ink container to be secured together by said guides.

6. The compatible ink cartridge of a large format ink jet printer of claim 1, wherein there are fixing points on the interiors of the left and right walls of said cartridge, there are matching fixing points on said ink container that correspond to said fixing points of said cartridge.

7. The compatible ink cartridge of a large format ink jet printer of claim 1, wherein a stabilizer seals said soft plug inside said outlet.

8. The compatible ink cartridge of a large format ink jet printer of claim 1, wherein a side wall of said cartridge is equipped with a microchip.

9. The compatible ink cartridge of a large format ink jet printer of claim 1, wherein said front end of said ink container has a locking part, said cartridge is formed by the left and right walls as a body-and-lid combination wherein one of said walls has a matching locking part that interlocks with said ink container's locking part.

10. A compatible ink cartridge of a large format ink jet printer, comprising a hard-bodied cartridge and an ink container that can be integrated with said cartridge to form an ink cartridge, the front end of said cartridge has a nozzle through which the large format ink jet printer's ink supply needle is inserted, said ink container has a front end facing said nozzle of said cartridge, said front end having a soft plug through which said ink supply needle can be inserted to access ink from said ink container.
